(19) United States
(12) Patent Application Publication
(10) Pub. No.: US 2006/0156973 A1
(43) Pub. Date: Jul. 20, 2006

(54) Coating system for forming protective layer

(76) Inventors: Bansei Nagase, Saitama-ken (JP); Hiromi Okubo, Saitama-ken (JP); Ichiro Hamasato, Saitama-ken (JP)

Correspondence Address: FISH & RICHARDSON P.C., P.O. BOX 1022, MINNEAPOLIS, MN, 55440-1022, US

(21) Appl. No.: 10/546,467

(22) PCT Filed: Feb. 20, 2004
(86) PCT No.: PCT/JP04/02022

§ 371 Date: Aug. 18, 2005

(30) Foreign Application Priority Data
Feb. 21, 2003 (JP) 2003-044141
Mar. 24, 2003 (JP) 2003-080797
Mar. 24, 2003 (JP) 2003-080822
Mar. 28, 2003 (JP) 2003-092249
Apr. 18, 2003 (JP) 2003-114069
Jul. 15, 2003 (JP) 2003-274564

(51) Int. Cl. B05C 11/02

(52) U.S. Cl. 118/109

(57) ABSTRACT

A coating system (10) for forming a protective layer includes a roller mechanism (34) provided at an end of an arm (46) of a robot (16a) as an end effector. The roller mechanism (34) has a roller (48), a holder (86) for supporting the roller (48), and a pipe (112). The holder (86) is removably attached to the roller (48). The pipe (112) supports the roller (48) in a freely rotating manner, and delivers the protective layer forming material to the roller (48).

### TECHNICAL FIELD

The present invention relates to a coating system which applies protective layer forming material to primarily the painted regions of the outer surface of a vehicle after painting, and in particular relates to a coating system which applies liquid protective layer forming material using a roller which is in close contact with the outer surface.

### BACKGROUND ART

Vehicles, such as cars, are often stored in stockyards and transported on trailers and ships or the like, after being manufactured and prior to being delivered to customers. During this period, the vehicles are exposed to dust, metallic powder, salt, oil, acid and to direct sunlight, and if they are stored or transported for a long period of time, the quality of the outer layer, of the vehicle's multiple layers of paint, may become degraded. In order to prevent this from happening, a method is known where a peelable protective layer is formed on the painted areas prior to shipping the vehicle (for example, Japanese Laid-Open Patent Publication No. 2001-89697). The peelable protective layer is formed by applying a liquid wrap or protective layer forming material (also called strippable paint) and drying the applied material, in order to protect the painted regions. Furthermore, this peelable protective layer can easily be peeled off when removing, but will not naturally peel off during normal storage.

The process of applying protective layer forming material prior to drying the peelable protective layer is performed by adhering the protective layer forming material to rollers, and then rolling the rollers along surfaces to apply the protective layer forming material.

In order to automate this operation and to make the application quality uniform, a method has been proposed where after pouring the protective layer forming material onto a vehicle body, air is blown to spread the protective layer forming material (for example, Japanese Laid-Open Patent Publication No. 08-173882). Through use of this method, many of the coating process operations are automated, reducing the load on the workers and improving cycle time, which is preferable.

However, when using the method disclosed in the Japanese Laid-Open Patent Publication No. 08-173882, spreading of the protective layer forming material is not necessarily uniform and in order to prevent scattering of the protective layer forming material, it is not applied to the edges of the roof.

Also, recent automobile bodies have become more complex, having recessed and raised regions that are complex with detailed curves. Using an air nozzle to spread the protective layer forming material over these recessed regions and curved surfaces is difficult. Moreover, for areas where the coating quality is extra important, the protective layer forming material needs to be applied extra thick, but it is difficult to control the thickness of the coating when the protective layer forming material is spread with an air nozzle.

Therefore, after spreading protective layer forming material with an air nozzle, it is necessary for multiple operators to finish the layer by applying protective layer forming material to the roof edges and in the detailed areas of the recessed regions or the like with rollers. Therefore the application process of the protective layer forming material depends in part on operators, becoming a burden to the operators and causing variability in the coating quality depending on the skill of the operators.

In order to reduce the amount of work required of operators as well as to make the operation quality more uniform, the use of industrial robots using rollers normally used by operators has been investigated. In this case, using a pump to automatically supply protective layer forming material to the roller is preferable.

However, the protective layer forming material supplied to the inside of the roller does not necessarily penetrate uniformly to the surface of the roller and it is especially difficult for the material to move to the ends of the roller, which dry out at times. As a result, the protective layer forming material applied to the vehicle is not uniform and at times is inconsistent.

On the other hand, the applicant of the present application has previously taken into account the need to improve the uniformity of the application quality and automation of the work, and proposed a coating system and application method as recorded in Japanese Patent Application No. 2002-381880. In the Japanese Patent Application No. 2002-381880, the process for applying protective layer forming material to the outer surface of the vehicle is further automated by using a roller operated by a robot, and this has made it possible to improve the uniformity of the application quality, while improving the manufacturing efficiency and simplifying the work.

### DISCLOSURE OF INVENTION

An object of the present invention is to provide a coating system which enables accurate application of protective layer forming material while improving the handling of a roller in close contact with the outer surface of an object being coated, when applying protective layer forming material to the surface of the object.

Additionally, another object of the present invention is to provide a coating system for forming a protective layer that enables both the accurate and favorable application of a protective layer forming material.

A coating system for forming a protective layer according to the present invention includes a coating device disposed near a transport line for the object to be coated. The coating device moves according to teaching by an operator. Further, the coating system includes a roller mechanism equipped with a roller that can freely rotate, and a supply mechanism that supplies a liquid material (protective layer forming material) to the roller to form a peelable protective layer after drying. The roller mechanism is equipped with a holder that supports the roller in a manner such that the roller can be attached and removed, and a hollow pipe which is attached to the holder, and supports the roller in a freely rotating manner while supplying the liquid material to the roller.

By constructing the roller in a manner that enables attaching and removing using a roller mechanism, the handling of the roller is improved. As a result, it becomes possible to perform maintenance on the roller efficiently. Furthermore, using the pipe to support the roller as well as to supply protective layer forming material directly to the roller leads to simplification of the structure of the roller mechanism.

In this case, if the coating device is a robot, and the object to be coated is a vehicle, the robot is able to follow the complex shape of the vehicle, and this is preferable.

The holder comprises a holder main body which is parallel to the roller, and a fixed holder and a moveable holder, extending from ends of the holder main body, that support the ends of the pipe, and the moveable holder should be supported by the holder main body in a manner that is able to turn. Therefore, it is possible to improve the handling ability of the roller. As a result, it is possible to perform maintenance on the roller more efficiently.

The moveable holder can be operated by an elastic body in either a support position for supporting the roller, or in a detachment position rotated from the support position. When the moveable holder is in the support position, it has the ability to reliably support the roller or the pipe. Furthermore, when the moveable holder is in the detachment position, the roller is easily attached and removed.

Additionally, the roller should have an applicator for applying the protective layer forming material while in close contact with the outer surface of the object to be coated, and end caps which are attached to be liquid tight to both ends of the roller and which have a pipe inserted therethrough, and which support the roller in a manner which can freely rotate. Therefore, the construction of the roller can be simplified while reliably applying protective layer forming material.

The pipe is connected at a first end to a coating material duct which supplies the protective layer forming material, and the outer circumference of the pipe has multiple holes formed along the axial direction of the pipe, and the holes near a second opposing end of the pipe may be larger than the holes near the first end.

In this manner, as protective layer forming material is supplied to the pipe from the coating material duct, protective layer forming material is delivered to the inside of the roller through the multiple holes provided in the pipe. Therefore, it is possible to automatically and continuously supply protective layer forming material to the roller, making it easy to improve the efficiency of the coating operation.

At this time, because the first end of the pipe is connected to the coating material duct, it is easy for the protective layer forming material to flow through the holes in the first end. Therefore, if the holes near the second end are made with a larger diameter than the holes near the first end in the pipe, it is possible to have a near uniform flow of protective layer forming material per unit area along the axis of the pipe through each of the holes. Thus, it is possible to supply protective layer forming material uniformly over the entire length of the roller in the axial direction, making possible a highly precise coating operation with an improvement in uniformity of the coating quality with a simple construction.

It is also possible to make the spaces between the holes near the second end to be closer together than the spaces between the holes close to the first end of the pipe.

Therefore, it is possible to have a uniform flow of protective layer forming material per unit area through all of the holes, which makes it possible to supply the protective layer forming material uniformly over the entire length of the roller in the axial direction. Therefore, a highly precise coating operation with an improvement in uniformity of the coating quality is possible with a simple construction.

Additionally, it is beneficial for the roller to be equipped with a cylindrical brush base inside of which the protective layer forming material is supplied, and a brush on the outer surface of the brush base, and for multiple holes of the brush base which pass the protective layer forming material which has been supplied inside to the brush, to be opened in a spiral or lattice configuration along the outer circumference of the brush base in the axial direction.

In this manner, multiple holes are opened in a spiral or lattice configuration along the axial direction of the outer circumference of the brush base. Therefore, when the roller rotates to apply protective layer forming material, the protective layer forming material can be reliably and uniformly supplied to the application surface. Therefore, an efficient and high quality operation of applying the protective layer forming material can be achieved with a simple construction.

In addition, the brush base may be constructed of paper impregnated with plastic material. This makes the brush base both lightweight and economical as well as making it possible to effectively increase the strength of the brush base itself.

It is also possible to provide a cylindrical collar member positioned between the pipe and the roller, and the collar member is equipped with an opening to supply into the roller the protective layer forming material that is supplied into the collar member from the holes in the pipe.

When protective layer forming material is supplied to the pipe, the protective layer forming material is supplied into the collar member through the multiple holes made in the pipe. Therefore, it is possible for the protective layer forming material to rapidly fill the inside of the roller through the opening provided in the collar member thus maintaining a prompt response and an efficient coating operation for the protective layer forming material.

In this case, the collar member is provided with multiple sections separated in the radial direction, and it is acceptable to form slit shaped grooves extending in the axial direction of the roller as the openings between each of the sections. Therefore, protective layer forming material can be applied uniformly along the entire axis of the roller, leading to a highly precise coating operation that has consistent application quality using a simple construction.

If the collar member is made of two sections separated in the radial direction, it is possible to clean the inner surfaces of the collar member and assembly will be easy.

Additionally, the collar member may have multiple guide holes which penetrate in the radial direction as the openings, and the protective layer forming material, which is supplied to the guide holes from holes in the pipe, is discharged into the roller from the outer circumference of the collar member through the guide holes. In this manner, protective layer forming material is supplied into the roller reliably and uniformly, making it easy to have a favorable coating operation.

Additionally, it is acceptable to provide end caps attached to both ends of the roller, which are built as a single piece with the roller in a manner that allows free rotation of the roller with respect to the pipe by passing the pipe directly through the end caps. Therefore, bearings or the like are not required between the pipe and the roller end caps, and it is possible to both lighten the roller mechanism and make it smaller. Moreover, as this reduces the number of required parts, the roller mechanism can be produced economically.

The roller is equipped with a cylindrical applicator on the outer surface, and at least one of the guide holes may be formed to incline or curve closer to the ends in the axial direction from the inner surface toward the outer surface.

In this manner, because guide holes are provided in the collar member which pass through from the inner surface to the outer surface, and the guide holes are formed to incline or curve in the direction closer to the ends, protective layer forming material can reliably be supplied to the end regions. Therefore, the film of protective layer forming material applied to the vehicle will be uniform, and protective layer forming material can be reliably and satisfactorily applied.

In this case, if at least one of the guide holes links to the end(s) of the outer surface of the collar member, it is possible to more reliably supply protective layer forming material to the end(s).

The holder may have either a penetrating hole or a recessed region.

Forming a penetrating hole or recessed region in the holder makes it possible to reduce the weight of the holder. Therefore, because it is possible to reduce the moment of inertia created by the moving operation of the roller mechanism by reducing the weight of the roller mechanism, it is possible to control the pivot operation of the roller mechanism even more easily and smoothly.

Additionally, the holder is made up of a holder main body which is parallel to the roller, and a fixed holder and a moveable holder which support the ends of the pipe and extend from each end of the holder main body, and it is acceptable for a cutaway to be cut in the ends of the fixed holder and the moveable holder at location(s) corresponding to the surface of the object to be coated in order to avoid interference with the surface as protective layer forming material is applied. Therefore, when the roller mechanism that applies the protective layer forming material is set at a designated angle, contact between the vehicle and the support member can be avoided, and at the same time, the support member can be lightened by the cutaway in the support member.

Additionally, by forming a puncture hole or groove in at least one of either the fixed holder or moveable holder, it is possible to lighten the support member and to more easily and smoothly control the pivot motion of the roller mechanism.

Acrylic copolymer material should be used as the raw material for the protective layer forming material. Therefore, it is possible to reliably protect the painted regions of the vehicle, and moreover, it is easy to peel off when removing.

The above and other objects, features and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a perspective view of a coating system according to an embodiment of the present invention.

FIG. 2 is a front perspective view of the coating system.

FIG. 3 is a perspective view of the robot and the roller mechanism provided in this robot in the coating system.

FIG. 4 is an expanded perspective view of the roller mechanism.

FIG. 5 is a front view cross sectional view of a portion of the roller mechanism.

FIG. 6 is a side view of the roller mechanism.

FIG. 7 is a disassembled perspective view showing features of the roller mechanism.

FIG. 8 is a chart concerning differences in the amount of flow between when each hole is the same size and when the holes are of different sizes.

FIG. 9 is a composite schematic view of liquid pressure and air pressure systems of the coating system.

FIG. 10 is a side elevational view that shows the positional relationship between the surface of the vehicle and a robot for the process in which the robot is moved in the right direction.

FIG. 11 is a side elevational view that shows the positional relationship between the surface of the vehicle and robot for the process in which the robot is moved in the left direction.

FIG. 12 is a disassembled perspective view of the roller mechanism according to a first alternate embodiment of the invention.

FIG. 13 is a front cross sectional view of part of the roller mechanism according to a second alternate embodiment of the invention.

FIG. 14 is a disassembled perspective view of a feature of the roller mechanism according to the second alternate embodiment.

FIG. 15 is a disassembled perspective view of a feature of the roller mechanism according to a third alternate embodiment of the invention.

FIG. 16 is a frontal cross sectional view of part of the roller mechanism according to a fourth alternate embodiment of the invention.

FIG. 17 is a disassembled perspective view of a feature of the roller mechanism according to the fourth alternate embodiment of the invention.

FIG. 18 is an explanation cross sectional view of a feature of the roller mechanism according to the fourth alternate embodiment.

FIG. 19 is a frontal cross sectional view of part of the roller mechanism according to a fifth alternate embodiment of the invention.

FIG. 20 is a disassembled perspective view of a feature of the roller mechanism according to the fifth alternate embodiment of the invention.

FIG. 21 is a cross sectional view of a feature of the roller mechanism according to the fifth alternate embodiment.

FIG. 22 is a cross sectional schematic representation showing the collar member with penetrating inclined guide hole(s) near the ends thereof.

FIG. 23 is a cross sectional schematic representation showing a centered symmetrical view of the collar member where all of the guide holes are inclined.

FIG. 24 is a cross sectional schematic representation that shows a collar member that has angled guide holes.

FIG. 25 is a perspective schematic representation that shows a collar member that has guide holes twisted in the axial direction.

FIG. 26 is a cross sectional view of a feature in the roller mechanism structure of the coating system for forming a protective layer in a roller mechanism according to a sixth alternate embodiment of the invention.

FIG. 27 is a perspective view of the roller mechanism according to a seventh alternate embodiment of the invention.

FIG. 28 is a frontal cross section view of part of the roller mechanism according to the seventh alternate embodiment.

FIG. 29 is a side view of the roller mechanism according to the seventh alternate embodiment.

FIG. 30 is a side elevational view that shows the positional relationship between the robot and the surface of the vehicle when using a process where the holder connection is operated at an angle according to the invention.

### BEST MODE FOR CARRYING OUT THE INVENTION

Embodiments of the coating system for forming a protective layer of the present invention are explained with reference to the attached drawings below.

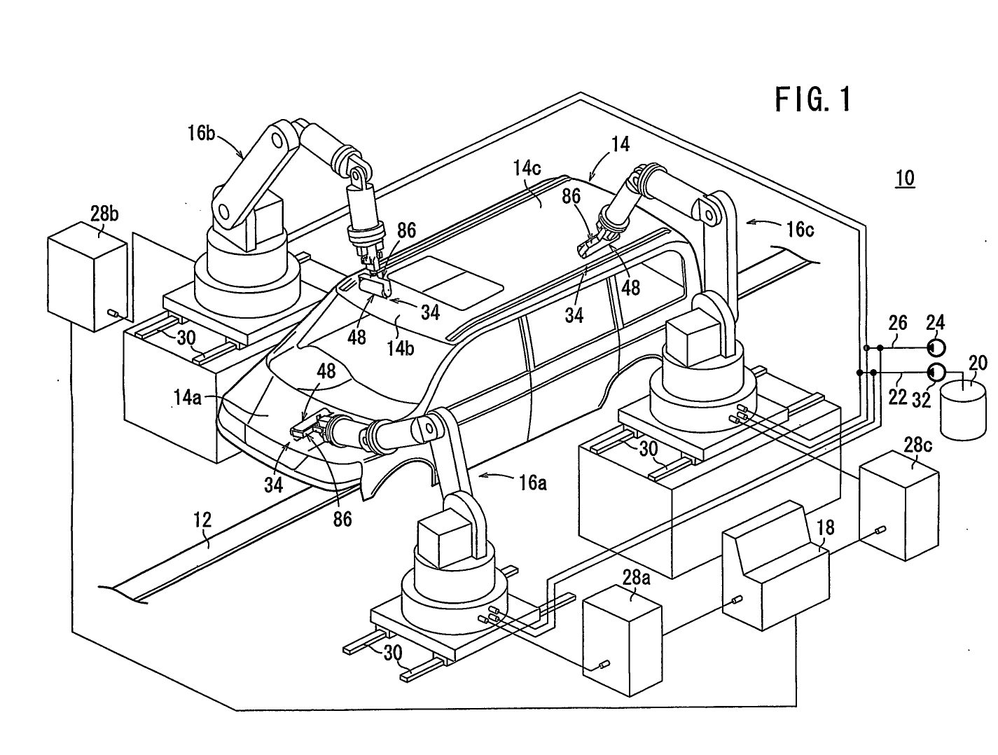

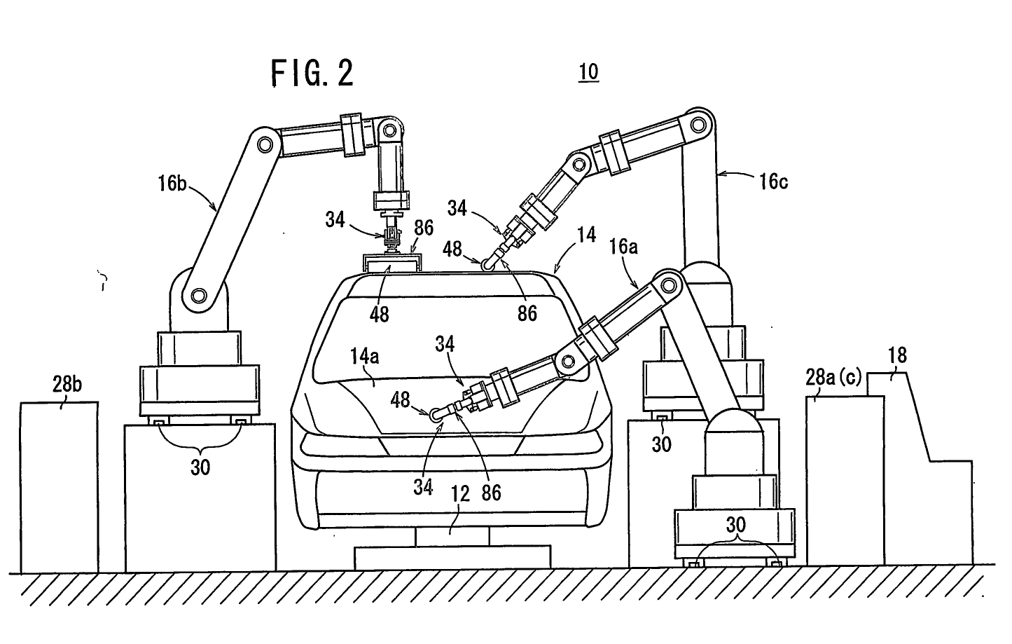

As can be seen in FIG. 1 and FIG. 2, the coating system 10 according to an embodiment of the present invention is built on an automobile transport line 12, and applies protective layer forming material to a painted vehicles 14. The coating system 10 comprises three industrial robots 16a, 16b, 16c, a controller 18 that controls the entire system, a tank 20 where the protective layer forming material is stored, ducts 22 that connect from the tank 20 to each of the robots 16a, 16b, 16c, and water ducts 26 that supply water from a water supply source 24 to the robots 16a, 16b, 16c. The robots 16a, 16b, 16c are each controlled by robot controllers 28a, 28b, 28c, which are connected to the controller 18.

The robots 16a and 16c are built on the left side of the transport line 12 of the vehicle 14 with respect to the direction of movement and the robot 16b is located on the right side of the line with respect to the direction of movement. Additionally the robot 16a is provided at the front with respect to the direction of movement, the robot 16b is in the center with respect to the direction of movement, and the robot 16c is at the rear with respect to the direction of movement. The robots 16a, 16b, 16c are able to move along slide rail 30 that is parallel to the transport line 12.

A pump 32 is placed along the duct 22 and supplies the protective layer forming material from the tank 20 to the robots 16a, 16b, 16c. Additionally, the protective layer forming material temperature is controlled with a thermometer and heater that are not shown in the drawings. A roller mechanism 34 is provided on the end of each of the robots 16a, 16b, 16c and is supplied the protective layer forming material from the duct 22.

The raw material of the protective layer forming material is primarily acrylic copolymer and preferably is made up of 2 types of acrylic copolymers that have different glass transition temperatures. As a concrete example, the protective layer forming material shown in the Japanese Laid-Open Patent Publication No. 2001-89697 can be used. Additionally, the viscosity of the protective layer forming material can be adjusted by changing the temperature and ratio of water mixed, and when the protective layer forming material dries, it attaches to the vehicle 14 and can protect the painted areas of the vehicle 14 both physically and chemically, from dust, metallic powder, salt, oil, acid, and direct sunlight or the like. Furthermore, when the vehicle 14 is sold to a customer, the protective layer can easily be peeled off when removing.

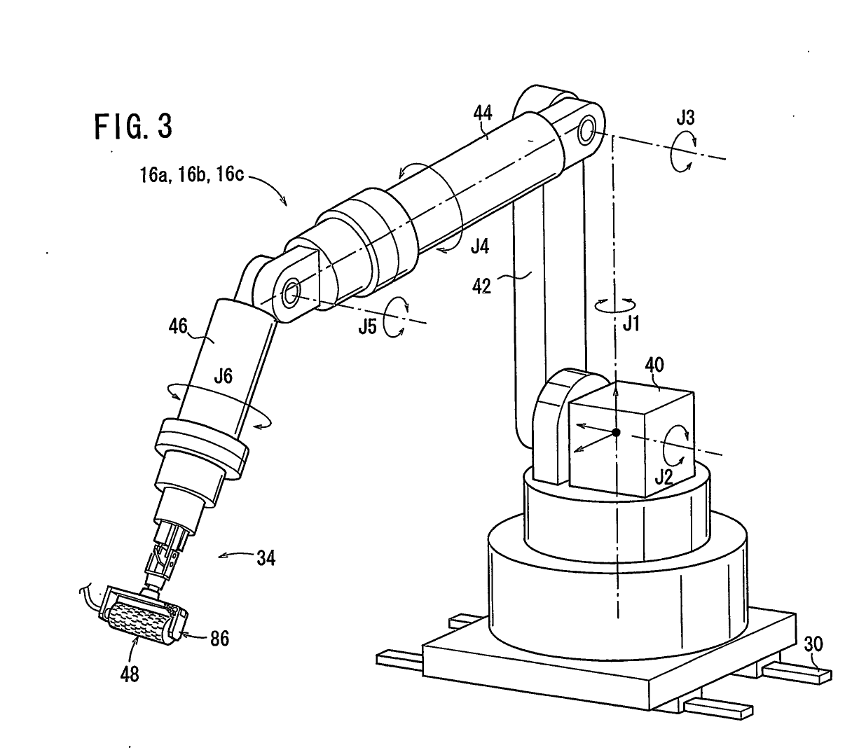

As can be seen in FIG. 3, for example, the robots 16a, 16b, 16c are multi-jointed industrial robots comprising a base 40, and in order from the base 40, a first arm 42, a second arm 44 and a third arm 46 with the roller mechanism 34 provided on the end of the third arm 46. The roller mechanism 34 can be freely attached to and removed from the third arm 46, or in other words, can act as an end effector. The first arm 42 is able to rotate with respect to the base 40 in the horizontal and vertical directions using axes J1 and J2. The second arm 44 is rotatably connected to the first arm 42 because of an axis J3. The second arm 44 is rotatable in a twisting manner because of an axis J4. The third arm 46 is rotatably connected to the second arm 44 because of an axis J5. The third arm 46 is rotatable in a twisting manner because of an axis J6.

With the robots 16a, 16b, 16c having this type of six-axis movement, it is possible to move the roller mechanism 34 attached to the end of the robots to any arbitrary position close to the vehicle 14, as well as in any arbitrary direction. In other words, the roller mechanism 34 can move with six degrees of freedom. The robots 16a, 16b, 16c may have moving parts which extend and retract, or are linked in parallel.

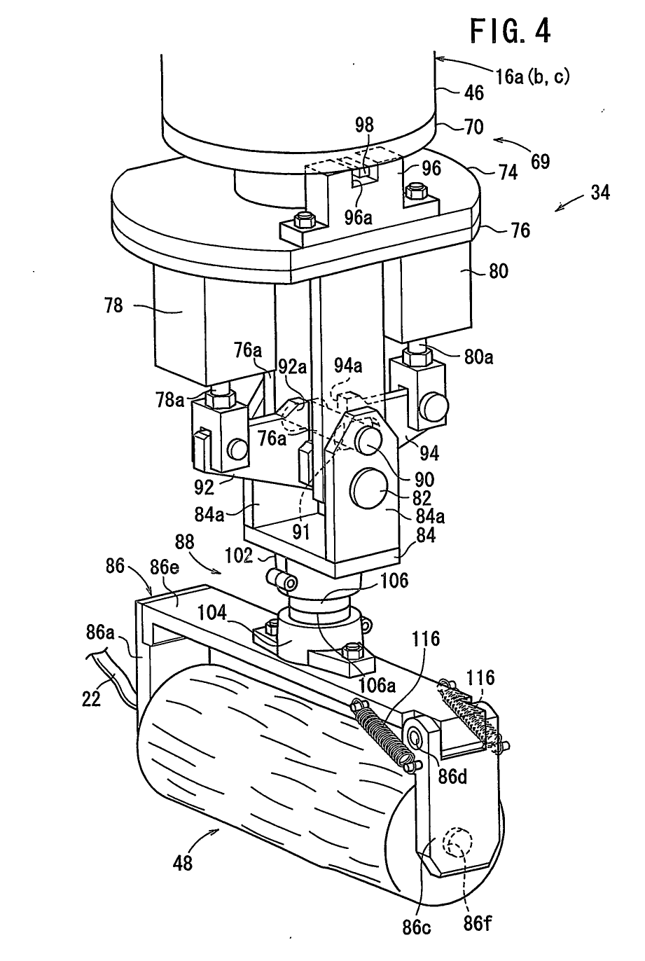

As can be seen in FIGS. 4 through 6, the roller mechanism 34 is attached to the end of the third arm 46 of robot 16a (or 16b, 16c), and comprises a roller 48 equipped with an applicator 48a that is cylindrical in form and can absorb and store the protective layer forming material, and a thrust rotator 69 that is an attachment of the third arm 46. The thrust rotator 69 comprises an attachment member 70, a thrust rotation member 74 which is supported with respect to the attachment member 70 in a manner that can freely rotate through bearing 72, and a base 76 which is attached to the bottom of the thrust rotation member 74.

Additionally, the roller mechanism 34 includes pneumatic cylinders 78 and 80 that are provided on both ends of the base 76, and a pivot member 84 which is supported by a pivot shaft 82 near the bottom end of the base 76 in a manner that can freely pivot, and a connection 88 that connects the pivot member 84 and a holder 86 that supports the roller 48. The pivot member 84 includes two upper extensions 84a that extend in the upward direction, and near the top end of the upper extensions 84a, a pin 90 is provided in parallel to the pivot shaft 82. The pin 90 is inserted in a manner which can freely move into a long hole 91 formed in a lower extension 76a above the first pivot shaft 82.

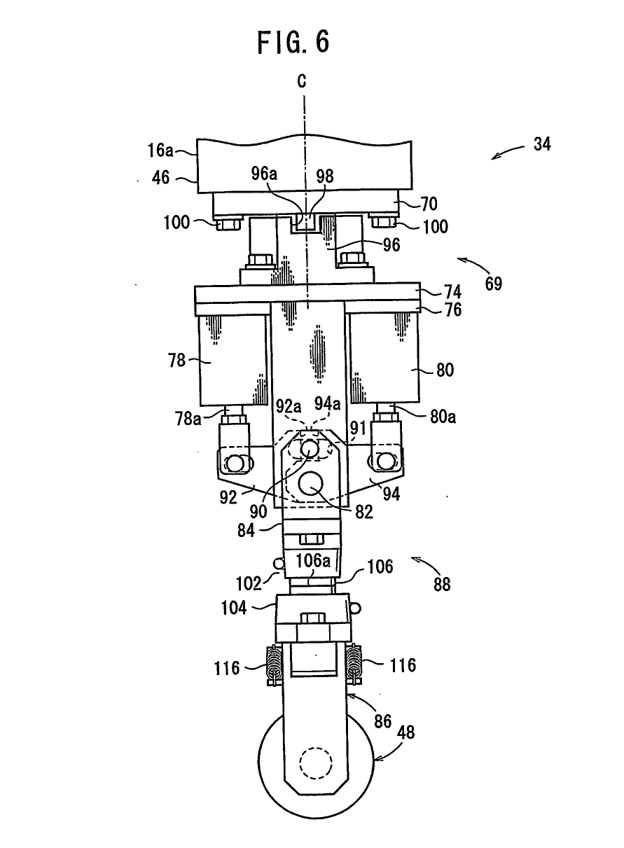

Additionally, the roller mechanism 34 receives a force from a rod 78a and a rod 80a of the pneumatic cylinders 78 and 80, and has pin pressing members 92 and 94 that rotate around the pivot shaft 82. A pressing surface 92a of the pin pressing member 92 pushes the left face of the pin 90 shown in FIG. 6 when the rod 78a retracts, and a pressing surface 94a of the pin pressing member 94 pushes on the right face of the pin 90 shown in FIG. 6 when the rod 80a retracts.

Two lower extensions 76a that extend from the base 76 are positioned between the two upward extensions 84a, and pressing surfaces 92a and 94a are positioned between the two lower extensions 76a.

A rotation regulator 96 is provided on top of the thrust rotation member 74, and a small protrusion 98 that extends from the bottom of the attachment member 70 is placed in a recessed region 96a of the upper surface of the rotation regulator 96. The width of the small protrusion 98 is slightly smaller than the width of the recessed region 96a and within the range of this gap, the thrust rotation member 74 can freely rotate in the thrust direction. The thrust direction discussed here is the direction orthogonal to the axis of the roller 48 and is a rotational direction using the axis C of the third arm 46 as the center axis. A bolt 100 which attaches the attachment member 70 to the third arm 46 may also be used as the small protrusion 98.

Two clamps 102 and 104 are provided as opposing upper and lower parts in the connection 88, and because an aluminum pipe 106 is supported by the clamps 102 and 104, the holder 86 and the pivot member 84 are connected. A circular groove 106a is provided on the surface of the aluminum pipe 106.

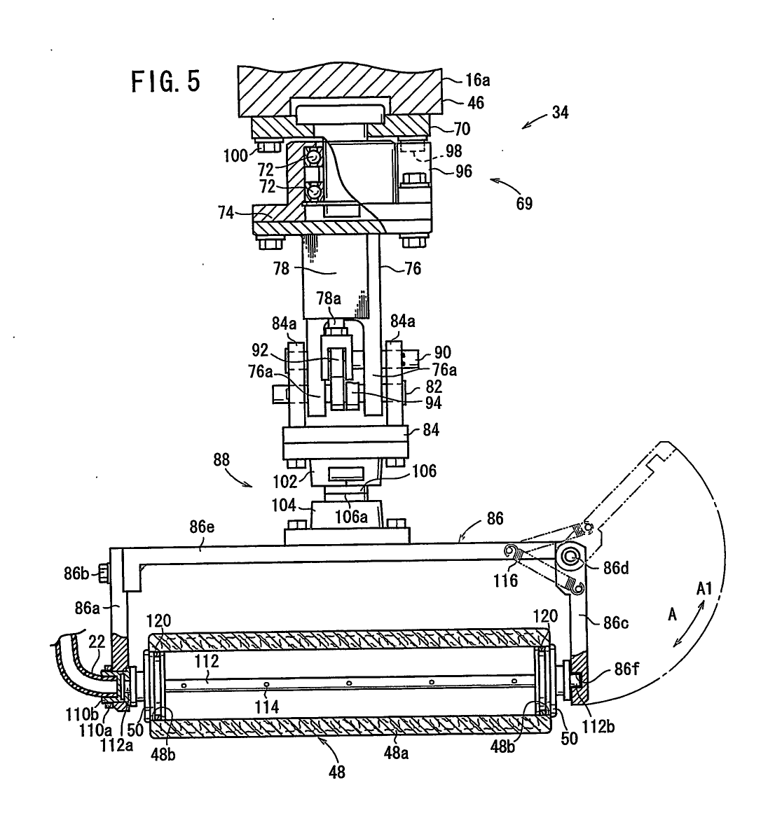

As can be seen in FIG. 4 and FIG. 5, the holder 86 is equipped with a holder main body 86e attached to a fixed holder 86a secured by a bolt 86b at one end, and attached to a moveable holder 86c through a shaft member 86d in a manner which can rotate freely on the other end. A connector 110b is secured with a nut 110a to the fixed holder 86a and the duct 22 is connected to an opening at one end of the connector 110b.

The holder main body 86e is slightly longer than the roller 48 and is a parallel flat member, and the fixed holder 86a and the moveable holder 86c that are provided on both ends support the roller 48 in a manner which can freely rotate through a hollow pipe 112.

On the other hand, a first end 112a of the pipe 112 is connected with the opening at the other end of the connector 110b. The protective layer forming material is supplied from the duct 22 to the roller 48 through the pipe 112. The pipe 112 supports the roller 48 such that the roller 48 freely rotates. The first end 112a has multiple (for example two) cone shaped grooves formed which are not shown in the drawings, and the pipe 112 is firmly secured to the connector 110b by coupling with an embedded bolt or the like that is not shown in the drawings, from the connector 110b side into the groove. A second end 112b of the pipe 112 is closed.

The pipe 112 has multiple holes formed for supplying to the roller 48 the protective layer forming material which has been supplied. The holes 114 may be formed in the shape of a nozzle. Additionally, it is preferable that the pipe 112 be formed from stainless steel, and it is, for example, even more preferable to be formed from SUS304 material (steel pipe classified as austenite class; according to Japanese Industrial Standard (JIS)).

The tip side of the moveable holder 86c has circular grooves 86f formed. The moveable holder 86c is able to rotate with the spring (elastic material) applying a force (reference direction of arrow A in FIG. 5). In other words, the moveable holder 86c moves to a retention position which connects the second end 112b of the pipe 112 to the circular groove 86f using the elastic force of a spring 116. Additionally, when attaching and removing the roller 48, the elastic force of the spring 116 will work in the opposite direction when the moveable holder 86c is moved a designated angle in the direction of arrow A1 by hand. In this manner, the moveable holder 86c will move to the detachment position, shown by the double chain lines on FIG. 5.

In this manner, the moveable holder 86c can easily move to either the support position or the detachment position by the action of the spring 116 and when in the support position, the pipe 112 can reliably be supported. Furthermore, when in the detachment position, the moveable holder 86c is set to a position that can sufficiently rotate as compared to the support position, and there is no inadvertent pivoting, so attaching and removing the roller 48 is easy.

Setting the rotation angle of the moveable holder 86c above 90 degrees is preferable, more preferable settings being between 100 and 180 degrees.

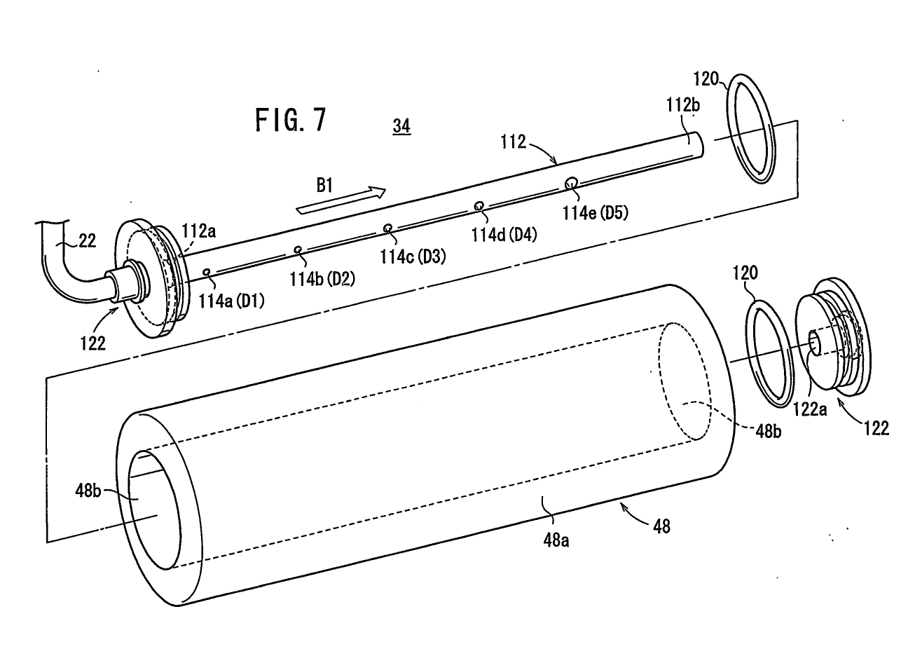

As can be seen in FIG. 5 and FIG. 7, the roller 48 is formed from a material that is able to absorb and store the protective layer forming material and is equipped with the hollow applicator 48a which applies the protective layer forming material by being in close contact with the surface of the vehicle 14, and end caps 50 that with o-rings 120 make openings 48b in both ends of the applicator 48a liquid tight. In the center of end caps 50 are holes that are not shown in the drawings, and the entire roller 48 is supported in a manner that can rotate freely because the pipe 112 is inserted through these holes. The level of mating of the pipe 112 and the holes is adjusted to retain the protective layer forming material inside the applicator 48a.

The pipe 112 has multiple holes 114a through 114e formed in order to supply to the roller 48 the protective layer forming material which had been provided. The holes 114a through 114e are made at an equal distance apart from the first end 112a to the second end 112b in the direction of arrow B1. The hole 114e near the second end 112b is formed with a larger diameter than the hole 114a near the first end 112a. In more detail, the diameters D1 through D5 of the holes 114a through 114e is set by, for example, the relationship D1=D2<D3=D4<D5.

Additionally, concerning the roller 48, the first end 112a of the pipe 112 is connected to the duct 22 and the protective layer forming material that is supplied from the duct 22 is discharged into the roller 48 through the holes 114a through 114e in the pipe 112. In this case, because the diameter of the holes 114a through 114e are set to, for example, D1=D2<D3=D4<D5, the protective layer forming material can be supplied uniformly over the entire length of the roller 48 in the axial direction.

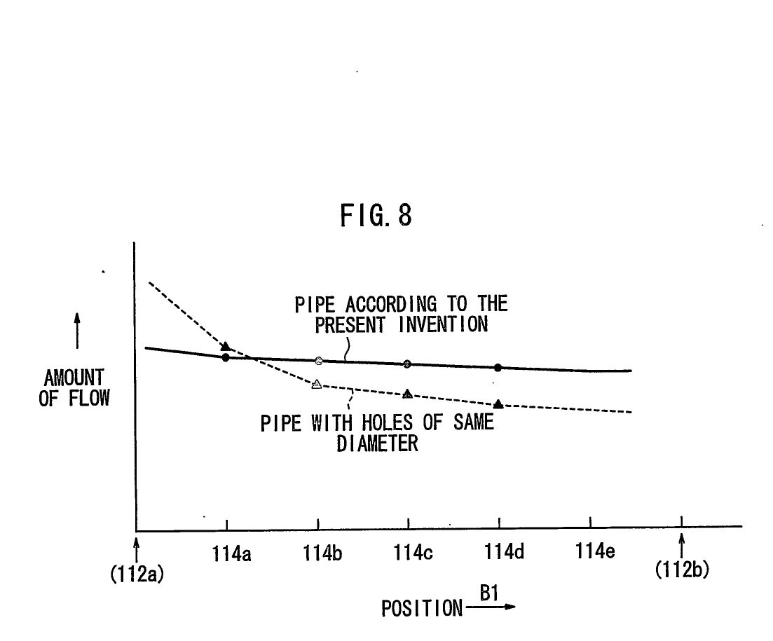

As is shown in FIG. 8, if the diameters D1 through D5 of the holes 114a through 114e are equal, the amount of the protective layer forming material that flows through the hole 114a near the first end 112a which is connected to the duct 22, will be more than the amount of the protective layer forming material that flows through the hole 114e near the second end 112b. Therefore, if the diameter D5 of the hole 114e near the second end 112b is formed with a larger diameter than the diameter D1 of the hole 114a near the first end 112a, a nearly uniform amount of the protective layer forming material will flow from the holes 114a, 114e. (Refer to solid line in FIG. 8).

Therefore, a nearly uniform amount per unit area of the protective layer forming material can flow out of the holes 114a through 114e along the axial direction of the pipe 112, and the protective layer forming material can be uniformly supplied along the entire length of the roller 48 in the axial direction. Therefore, a uniform application quality and a highly precise coating operation can be obtained using a simple construction.

Additionally, with the roller 48 and the holder 86 constructed in this manner, the roller 48 can easily be attached and removed, and the handling ability of the roller 48 can be improved. Therefore, even if frequent maintenance such as cleaning or exchanging of the roller 48 is required, this maintenance operation can be completed efficiently.

In addition, by constructing the roller 48 in the manner, the protective layer forming material delivered by the pipe 112 is received and stored by the applicator 48a and is reliably applied to the surface of the vehicle 14 by the applicator 48a.

Moreover, because nothing exists in the space between the applicator 48a and the pipe 112, the roller 48 will be lighter. Also, in preparation for the coating operation, a specified amount of the protective layer forming material can be placed in this space beforehand to prevent an insufficient supply of the protective layer forming material during the coating operation.

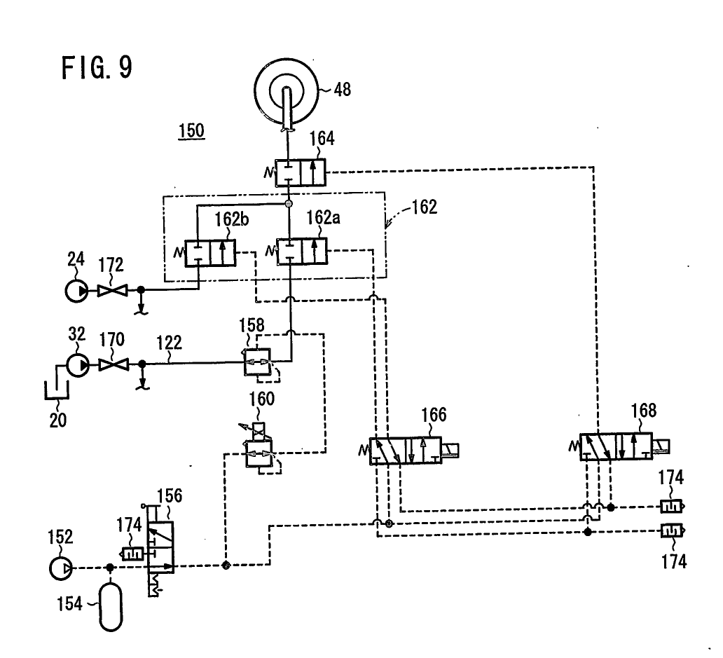

As can be seen in FIG. 9, a pneumatic and hydraulic composite system (supply mechanism) 150 that supplies the protective layer forming material to the roller 48 includes a compressor 152, an air tank 154 which is connected to the discharge port of the compressor 152, a manual pneumatic on-off valve 156 which switches to supply or cut off pneumatic air, a regulator operating valve 160 that lowers the secondary line pressure using an electric signal supplied by the controller 18, and a regulator 158 that reduces the pressure in the duct 22 using the secondary line pressure from the regulator operating valve 160 as a pilot.

Additionally, the composite system 150 includes an MCV (Material Control Valve) 162 that is connected to the secondary duct of the regulator 158 and the water duct 26, and a trigger valve 164 that is placed between the roller 48 and the secondary side of the MCV 162. Inside the MCV 162 are switching valves 162a, 162b that connect or cut off the duct 22 and the water duct 26, and the secondary side of the switching valves 162a, 162b are connected. Note: the dotted lines on FIG. 9 show the pneumatic lines.

The MCV 162, the trigger valve 164, and the regulator operating valve 160 are not restricted to pneumatic pilot valves, and may also be driven by an electric solenoid or the like.

The composite system 150 additionally includes an MCV switching electromagnetic valve 166 which uses a pilot method to operate the switching valves 162a, 162b that are supplied air pressure from pneumatic on-off valve 156, and trigger switching electromagnetic valve 168 which pilot operates the trigger valve 164. The MCV switching electromagnetic valve 166 opens one of the switching valves 162a, 162b and closes the other, based on an electric signal supplied by the controller 18, and switches supplying water and the protective layer forming material to the trigger valve 164. A trigger switching electromagnetic valve 168 opens and closes the trigger valve 164 and supplies water or the protective layer forming material to the roller 48 based on an electric signal supplied by the controller 18.

Manual stop valves 170, 172 are placed respectively along the duct 22 and water duct 26. Normally, the stop valves 170 and 172 are left open. Silencers 174 are provided at the air exhaust openings of the composite system 150 and reduce the air discharge noise. Relief valves (not shown in drawings) have been placed on the compressor 152, pump 32, and the water supply 24 to prevent pressure from rising to excessive levels.

Note, in the composite system 150, the compressor 152, the air tank 154, the water supply 24 and the pump 32 are common to the robots 16a, 16b, 16c, and the other equipment is provided separately for each of the robots 16a, 16b, 16c.

Next, the operation of applying the protective layer forming material to a vehicle using a coating system for forming a protective layer constructed in this manner, will be explained.

First, the motion of each of the robots 16a, 16b, 16c are taught beforehand. The robots 16a, 16b, 16c are assigned to the hood 14e, the middle of the roof 14b, and the back end of the roof 14c of the vehicle 14 respectively, and are taught to apply the protective layer forming material to the assigned area, and the teaching data used for teaching is recorded and held in the memory located in the controller 18 (refer to FIG. 1). Note, if the vehicle 14 is a sedan, the robot 16c is assigned to the trunk area.

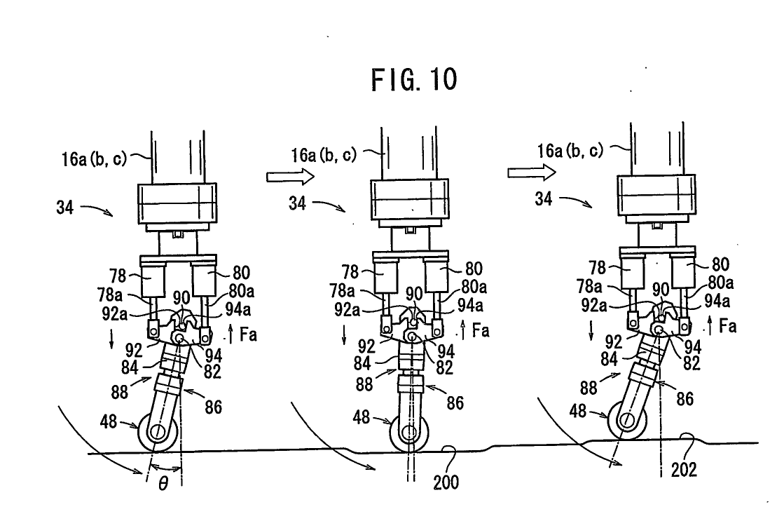

In other words, as can be seen in FIG. 10, teaching is performed such that the third arm 46 of the robot 16a is maintained at an adequate distance from the surface of the vehicle 14, and the angle of incline of the pivot member 84 is at a fixed angle θ. The incline angle of the pivot member 84 is basically maintained at angle θ, but shallow recessed areas 200 and short raised area 202 may be ignored, and the angle of the pivot member 84 slightly changed. By ignoring shallow recessed area 200 and short raised area 202 in this manner, motion teaching of the robot 16a becomes easy.

Next, as can be seen in FIG. 10, when the robot 16a is moved to the right as the protective layer forming material is applied to the vehicle 14, air is supplied to the right side pneumatic cylinder 80 so that a comparatively low force Fa is generated in the direction the rod 80a retracts. Furthermore, air is supplied to the left side pneumatic cylinder 78 so that the rod 78a will extend. Therefore, the pressure surface 94a of the right pin pressing member 94 presses with a relatively weal; force on the right surface of the pin 90, and pressing surface 92a of the left pin pressing member 92 separates from the pin 90. Therefore, the pivot member 84 and the roller 48 receive a force in the counterclockwise direction around the pivot shaft 82, and the roller 48 is pressed to the surface of the vehicle 14 with an appropriate press force.

Force Fa should be adjusted corresponding to the method of moving and the application area. This adjustment can easily be performed by either functioning pressing force adjustment function of the regulator 176 by the controller 18 or by using a designated dial or the like.

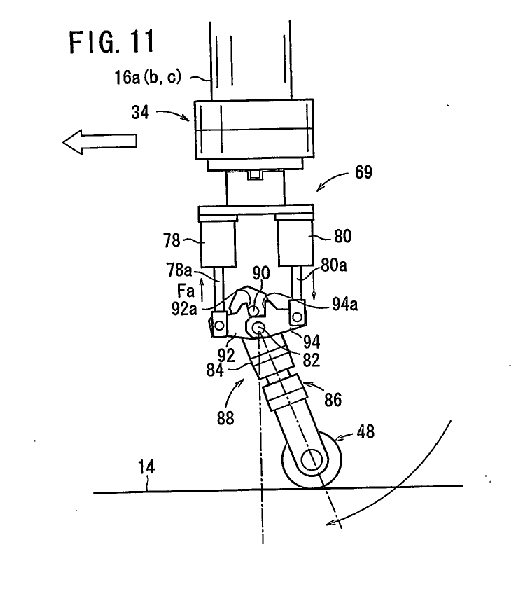

On the other hand, as can be seen in FIG. 11, when the robot 16a is moved to the left as the protective layer forming material is applied to the vehicle 14, air is supplied to the left side pneumatic cylinder 78 so that a comparatively low force Fa is generated in the direction the rod 78a retracts. Furthermore, air is supplied to the right side pneumatic cylinder 80 so that the rod 80a will extend. Therefore, pressure surface 92a of the left pin pressing member 92 presses with a relatively weak force on the left surface of the pin 90, and the pressing surface 94a of the right pin pressing member 94 separates from the pin 90. Therefore, the pivot member 84 and the roller 48 receive a force in the clockwise direction around the pivot shaft 82, and the roller 48 is pressed to the surface of the vehicle 14 with an appropriate press force.

In this manner, by controlling the direction of flow and pressure of air supplied to the pneumatic cylinders 78 and 80 depending on the direction the robot 16a is moving, the roller 48 can be appropriately pressed to the surface of the vehicle 14. In other words, along with effectively using the weight of the roller 48 as a pressing force, the force needed that is not supplied by this weight can be compensated for with the pressure of the pneumatic cylinder 78 and the pneumatic cylinder 80.

Therefore, the roller 48 will not spin freely and will not skip when passing over recessed area 200 or raised area 202. Furthermore, the protective layer forming material will easily exude from the roller 48. At this time, the roller 48 is able to pivot around the pivot shaft 82, and can reliably be kept in close contact with recessed area 200 and raised area 202, so the protective layer forming material can be applied. In other words, when the roller 48 passes over recessed area 200 and recessed area 202, the rod 78a or the rod 80a extend or retract depending on the depth of recessed area 200 or the height of raised area 202. The pneumatic cylinders 78 and 80 use highly compressible air as the drive medium, so soft motions are possible, and changes in external pressures can easily be absorbed. In other words, the first pneumatic cylinder 78 and the second pneumatic cylinder 80 have a pressing effect and a cushioning effect.

The pin pressing member 92 which is connected to the rod 78a of the pneumatic cylinder 78 and the pin pressing member 94 which is connected to the rod 80a of the pneumatic cylinder 80 apply pressing forces in opposing directions on the pivot member 84, so regardless of whether the pivot member 84 is angled in the clockwise direction or in the counterclockwise direction, the appropriate motion is possible. Therefore, the protective layer forming material can be applied while moving to either the left or to the right.

Afterward, the vehicle 14 which has the protective layer forming material applied by the robots 16a, 16b, 16c is transported to the next process by the transport line 12. Also, the robots 16a, 16b, 16c maintain a standby stance that will not interfere with the vehicle 14, and wait until a next vehicle 14 is introduced. At this time, the trigger valve 164 is closed and the supply of the protective layer forming material stopped.

The protective layer forming material that has been applied is allowed to either dry naturally or by forced air, and forms a peelable protective layer which protects the painted areas of the vehicle.

As described above, with a coating system 10 of this embodiment, the handling of the roller 48 can be improved by being able to attach and remove the roller 48 which is supported by the roller mechanism 34. As a result, maintenance of the roller 48 can efficiently be performed. Furthermore, the roller 48 is supported and supplied the protective layer forming material by the pipe 112, so the construction of the roller mechanism 34 can be simple. Furthermore, although the construction of the roller mechanism 34 has been simplified, the protective layer forming material can reliably be applied.

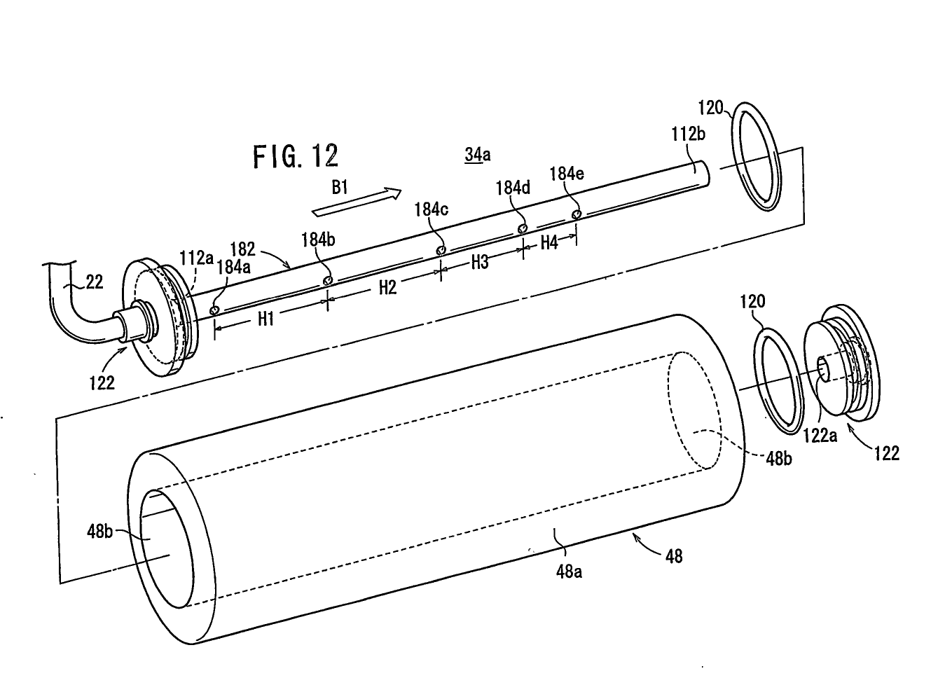

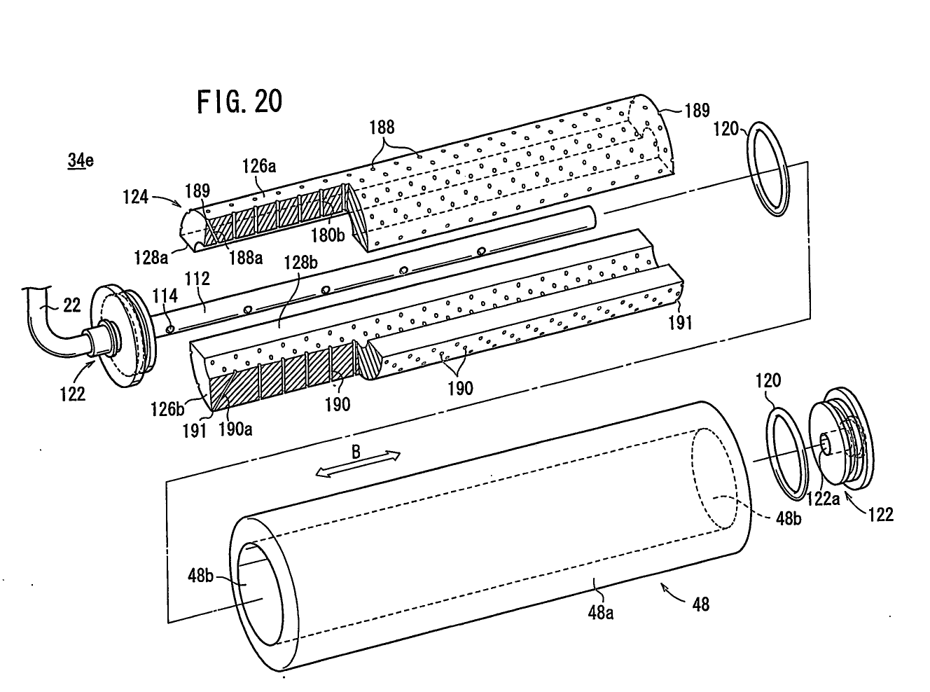

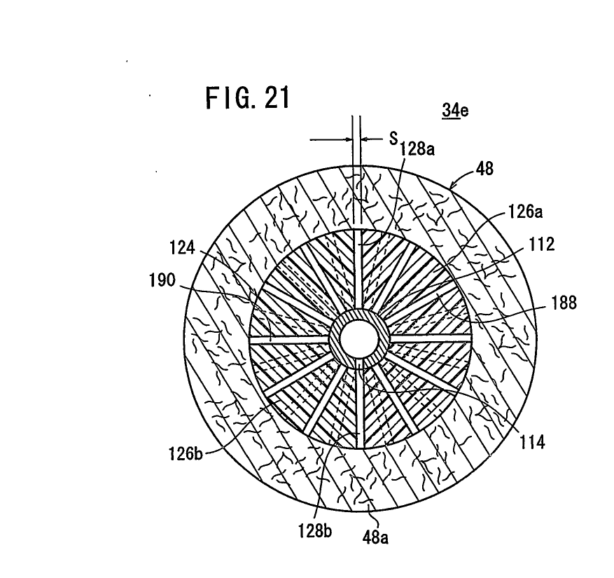

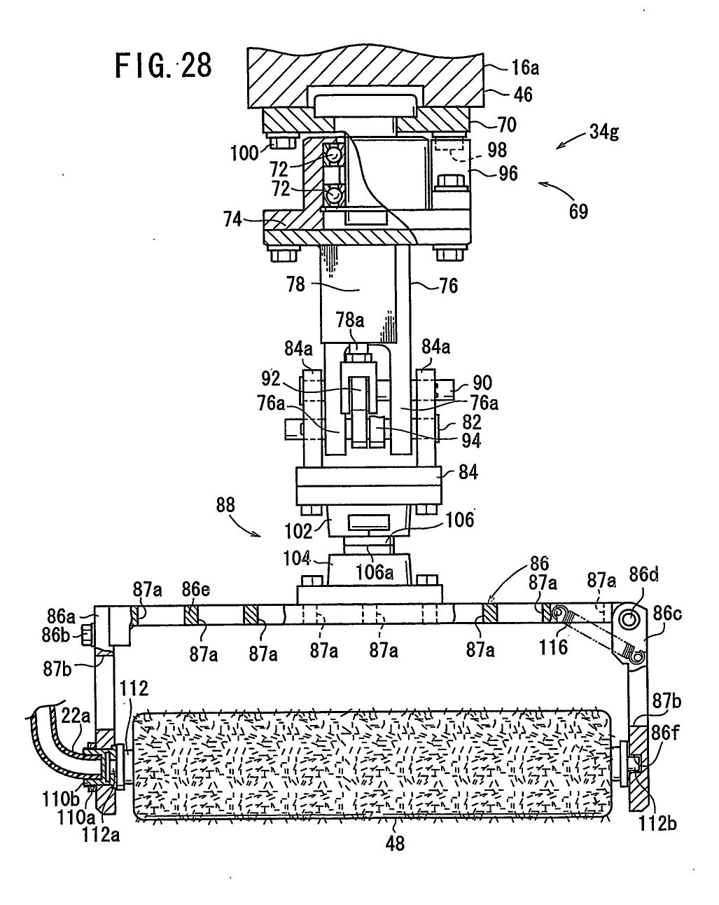

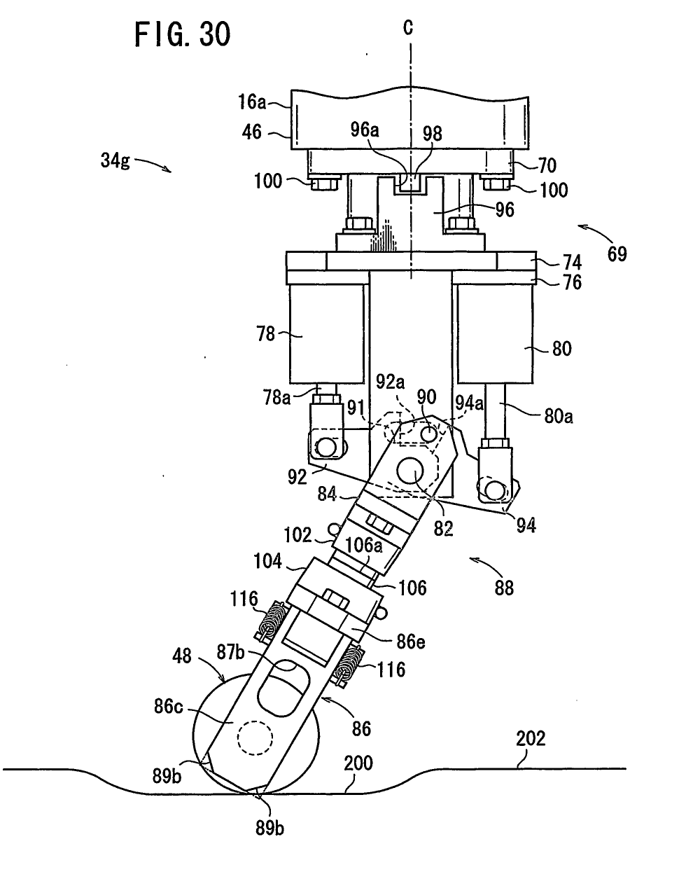

Next, first through seventh alternate embodiments of the roller mechanism 34 will be explained with reference to FIG. 12 to FIG. 30. Note, in the following description, the constituent elements that are the same as those in the previously mentioned roller mechanism 34 or as those in other alternate embodiments are labeled with the same reference numeral, and description thereof will be omitted.

As can be seen in FIG. 12, a roller mechanism 34a of the coating system for forming a protective layer according to the first alternate embodiment, is similar to the roller mechanism 34 with the pipe 112 (Refer to FIG. 7) replaced by pipe 182.

The roller mechanism 34a is equipped with a hollow pipe 182, and the pipe 182 has multiple holes 184a through 184e formed in order to supply to the roller 48 the protective layer forming material. The holes 184a through 184e have the same opening diameters, and are provided at intervals H1 through H4 in the direction of arrow B1 moving from the first end 112a to the second end 112b. Interval H4 between holes 184e and 184d which are close to the second end 112b, are smaller than interval H1 between holes 184a and 184b which are close to the first end 112a. Intervals H1 through H4 between the holes 184a through 184e are, for instance, set such that H1=H2>H3>H4.

With the roller mechanism 34a constructed in this manner, interval H4 between holes 184e and 184d which are close to the second end 112b are smaller than interval H1 between the holes 184a and 184b which are close to the first end 112a, so the protective layer forming material can be uniformly applied per area unit from the holes 184a through 184e along the axial direction of the pipe 182. In this manner, it is possible to uniformly supply the protective layer forming material along the entire length of the roller 48 in the axial direction, obtaining the same effectiveness as the roller mechanism 34.

Additionally, in the roller mechanism 34 equipped with the pipe 112, the holes 114a through 114e with set diameters D1 through D5 can have space H1 through H4 set the same as the roller mechanism 34a.

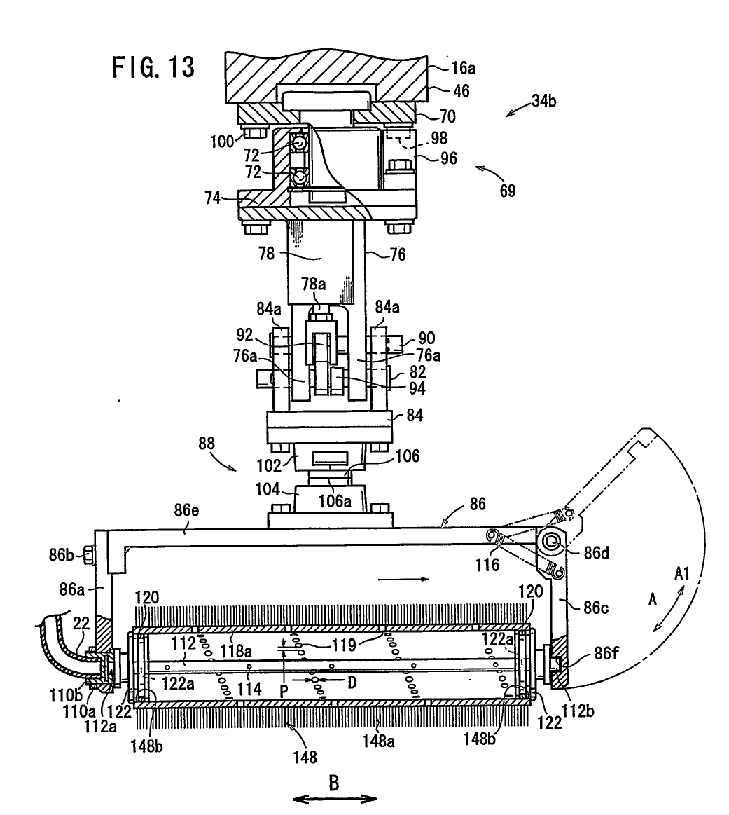

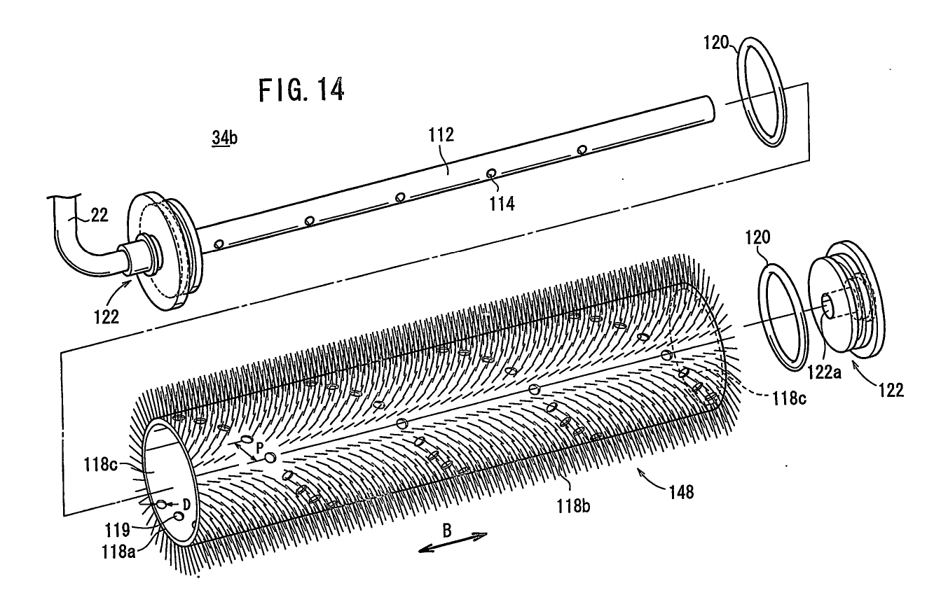

Next, a roller mechanism 34b according to the second alternate embodiment of the roller mechanism 34 will be described with reference to FIG. 13 and FIG. 14. The roller mechanism 34b is similar to the roller mechanism 34, with the roller 48 replaced by a roller 148.

As can be seen in FIG. 13 and FIG. 14, the roller 148 is supported by the roller mechanism 34b such that it can freely rotate and is equipped with a cylindrical brush base 118a into which the protective layer forming material is supplied, and brush (applicator) 118b which is provided on the outer circumference of the brush base 118a and which closely contacts the surface of the vehicle 14, and applies the protective layer forming material.

The brush base 118a is made from lightweight material, for example, such as paper which is impregnated with plastic material such as Phenol. In order to transmit the protective layer forming material supplied into brush base 118a to brush 118b, multiple spiral holes 119 are formed in the outer circumference of the brush base along (in the direction of B arrow) the axial direction. Each hole 119 has a diameter D of, for example, 1.8 mm and a pitch P of 20 mm.

With the roller mechanism 34b, when the roller 148 rotates to apply the protective layer forming material, the protective layer forming material can uniformly be supplied along both the axial and radial directions to the brush 118b of the rotating roller 148. Therefore, the protective layer forming material can uniformly and reliably be supplied to the application surface, and therefore, an efficient and high-quality coating operation for the protective layer forming material can be obtained with a simple construction.

In addition, the brush base 118 is made of paper impregnated with plastic material, so brush base 118a can be lightweight and economical, and the strength of the brush base 118a itself can be effectively increased.

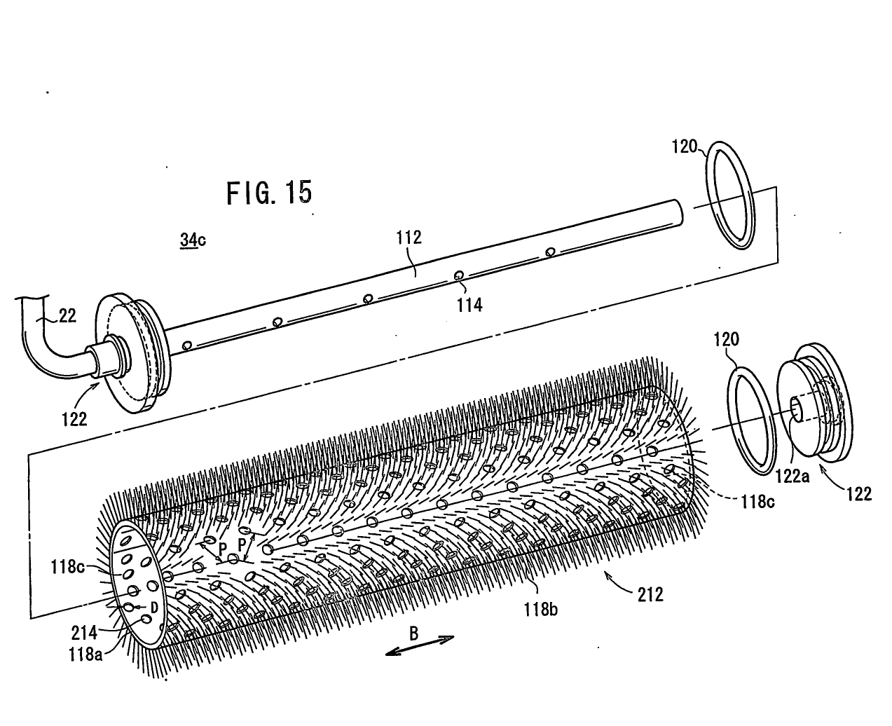

Next, a roller mechanism 34c according to the third alternate embodiment of the roller mechanism 34 will be described with reference to FIG. 15. The roller mechanism 34c is similar to the roller mechanism 34, with the roller 48 replaced by a roller 212.

The roller mechanism 34c supports the roller 212 in a manner that can rotate freely, and the brush base 118a which is a part of the roller 212 has multiple holes 214 formed to transmit into the brush base 118a the protective layer forming material supplied. Holes 214 are formed in a lattice configuration along the outer circumference in the axial direction of brush base 118a. Each of the holes 214 has , for example, a diameter D of 1.8 mm and a pitch ′P between mutually adjacent holes 214 of 20 mm.

With the roller mechanism 34c constructed in this manner, when the roller 212 rotates in order to apply the protective layer forming material, the brush area 118b of the rotating roller 212 can be uniformly supplied the protective layer forming material in the axial and circumferential directions. Therefore, the protective layer forming material can be supplied to the application surface both uniformly and reliably, and therefore, an efficient and high-quality coating operation for the protective layer forming material, similar to the effect of the roller mechanism 34b, can be obtained with a simple construction.

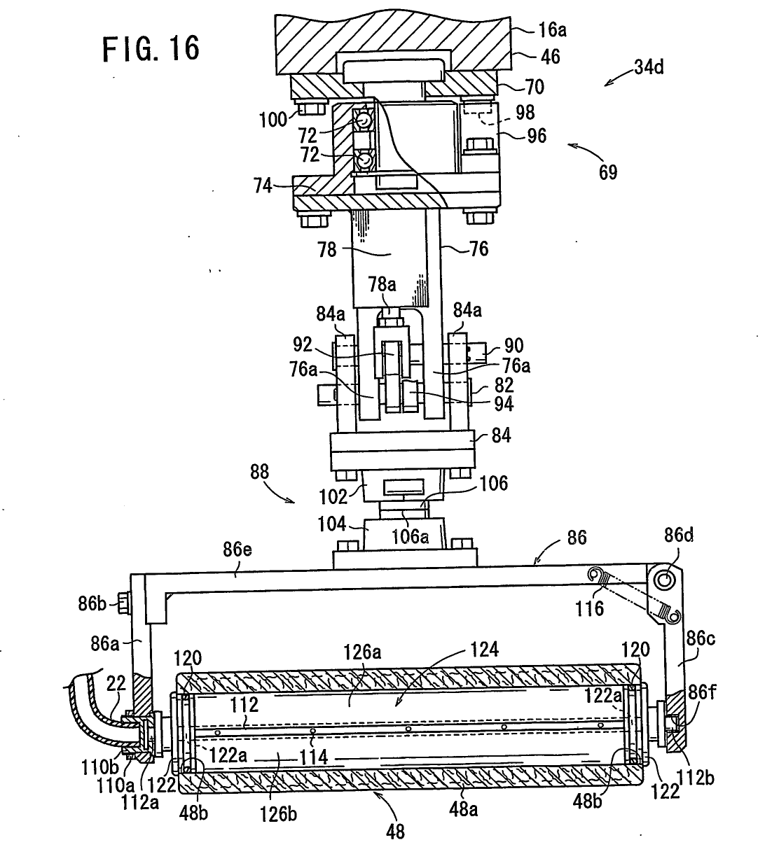

Next, a roller mechanism 34d according to the fourth alternate embodiment of the roller mechanism 34 is described with reference to FIG. 16 to FIG. 18. The roller mechanism 3d has the collar member 124 added to the roller 48 of the roller mechanism 34.

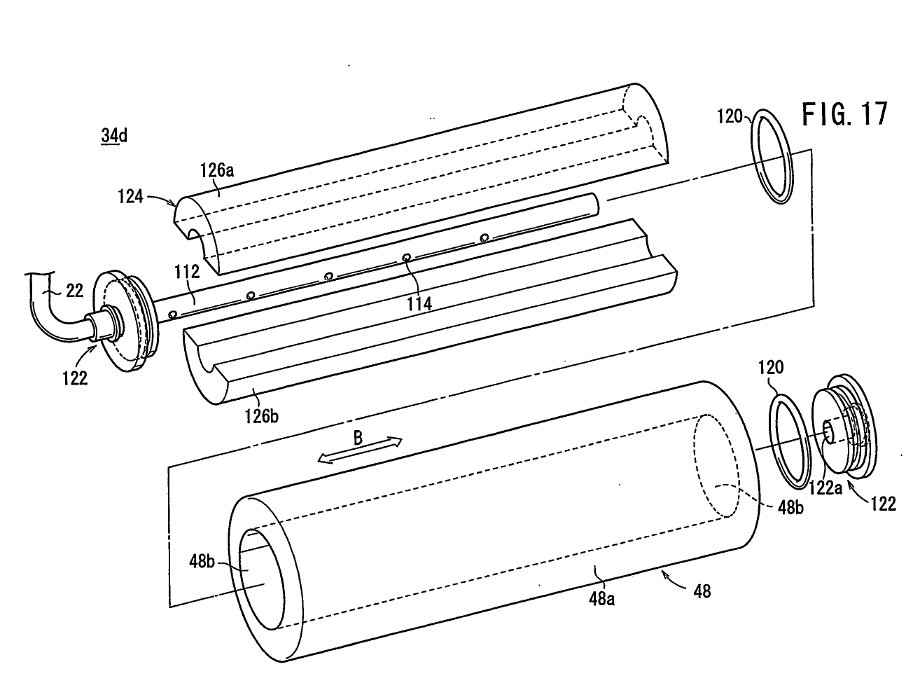

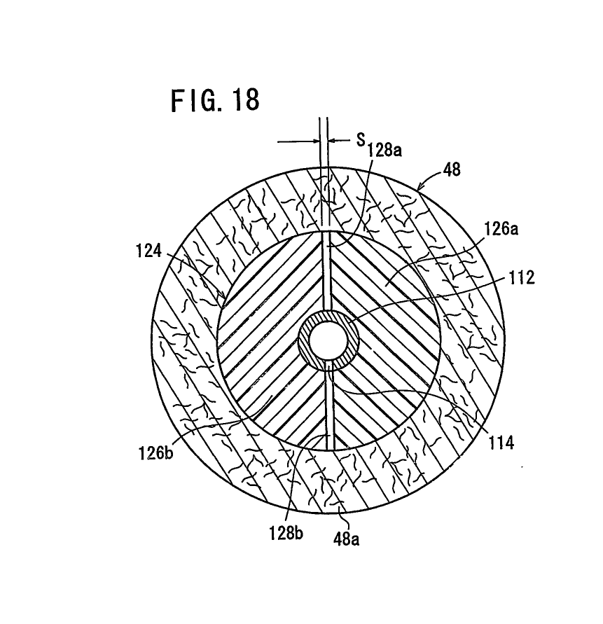

As can be seen in FIG. 16 to FIG. 18, the cylindrical collar member 124 is placed between the pipe 112 and the roller 48. In order to make the color member 124 lighter, for example, the collar member 124 is made of plastic and has multiple, for example two, sections 126a, 126b divided in the radial direction. Slit shape grooves 128a, 128b extending in the axial direction of the roller 48 (in the direction of arrow B in FIG. 17) are formed between the sections 126a, 126b. The grooves 128a, 128b make a fixed width gap S (refer to FIG. 18).

In the case of roller mechanism 34d, the first end 112a of the pipe 112 is connected to the duct 22 and the protective layer forming material supplied from the duct 22 flows in to the collar member 124 through the hole 114 in the pipe 112.

The protective layer forming material is delivered from the grooves 128a, 128b into the roller 48 along the radial and axial directions, so that the protective layer forming material can be supplied uniformly along the axis of the entire roller 48. Therefore, an efficient and high-quality coating operation for the protective layer forming material can be obtained using a simple construction.

Also, because the collar member 124 is stored in the roller 48, the required quantity of the protective layer forming material needed in the roller 48 is quickly replenished. This is because the empty space inside the roller 48 has been greatly reduced. Therefore, compared to constructions that do not use the collar member 124, highly responsive coating operation for the protective layer forming material can be carried out efficiently.

In addition, because the grooves 128a, 128b have been formed between the sections 126a, 126b which are separated, the construction of the collar member 124 has been simplified, allowing the collar member 124 to be produced more economically.

In addition, for example, bearings are not required to be placed between the pipe 112 and the end caps 122, so the whole roller mechanism 34 can be made smaller as well as lighter. Additionally, the number of parts is reduced, and the roller mechanism 34 can be produced economically.

Because the collar member 124 can be divided into 2 sections 126a and 126b, the inner surface can be cleaned and easily assembled. In other words, when assembling the sections 126a and 126b, the pipe 112 is simply placed between the sections 126a and 126b.

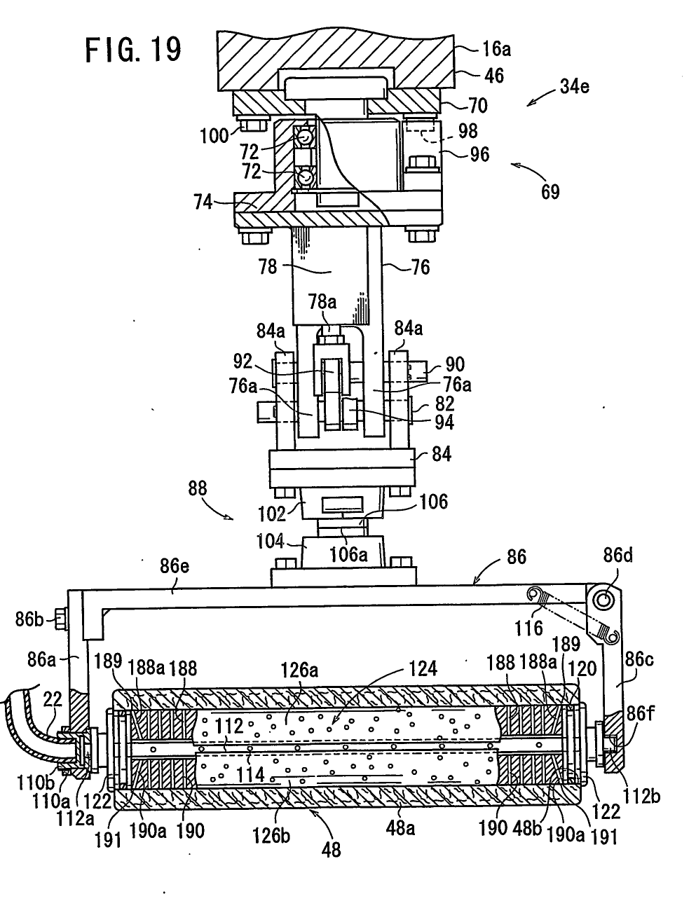

Next, a roller mechanism 34e according to the fifth alternate embodiment of the roller mechanism 34 will be described with reference to FIG. 19 through FIG. 21. The roller mechanism 34e is similar to the roller mechanism 34d with guide holes 188, 188a, 190, 190a provided in the collar member 124.

As is shown in FIG. 19 through FIG. 21, multiple guide holes (openings) 188, 190 that penetrate from the center of the collar member 124 in the radial direction are made in the sections 126a, 126b of the roller mechanism 34e. The guide holes 188, 190 are staggered along the outer wall of the sections 126a, 126b, and are uniformly dispersed in the axial direction.

Of the multiple guide holes 188, guide holes 188a at both ends of the section 126a are inclined towards end(s) 189 in the axial direction from the inside surface to the outside surface, and there is an opening at the end 189. Similarly, of multiple guide holes 190, guide holes 190a at both ends of the section 126b are inclined towards end(s) 191 in the axial direction from the inside surface to the outside surface, and there is then opening at the end 191.

With the roller mechanism 34e formed in this manner, the protective layer forming material supplied from the duct 22 flows from the holes 114 in the pipe 112 to the collar member 124. At this time, slit grooves 128a, 128b extending in the axial direction of the roller 48 are formed between the sections 126a, 126b that form the collar member 124, and the sections 126a, 126b have the multiple guide holes 188, 190 that penetrate in the radial direction.

Therefore, the protective layer forming material is delivered into the roller 48 along grooves 128a, 128b, and flows into the roller 48 through multiple guide holes 188, 190 because of the centrifugal force caused by the rotation of the collar member 124. Therefore, the protective layer forming material can reliably and uniformly be supplied in the axial direction along the entire length of the roller 48, and therefore, an efficient and high-quality coating operation for the protective layer forming material, similar to the effect of the roller mechanism 34d, can be obtained with a simple construction.

Additionally, the two sections 126a and 126b that form the collar member 124 are equipped with guide holes 188a and 190a that connect to the ends 189 and 191 of the outer surface, so the protective layer forming material that flows from hole(s) 114, passes through the guide holes 188a and 190a, is reliably supplied to both ends of the collar member 124 (in other words the ends 189, 191, of the sections 126a, 126b) and then soaks into both ends of the applicator 48a. Therefore, drying of both ends of the applicator 48a can be prevented.

Therefore, the protective layer forming material will permeate through to the applicator 48a in a uniform manner, and will make a consistent coating of the protective layer forming material applied to the vehicle 14. Also, uneven application will not occur.

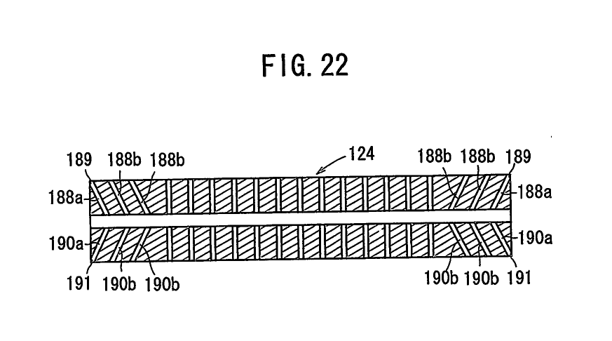

In addition, as can be seen in FIG. 22, the guide holes 190 which are opened at areas slightly nearer the center than the end 189 can be inclined in the axial direction toward the end 189 from the inner surface to the outer surface, similar to the guide holes 188a. Similarly, the guide holes 190b opened in areas slightly nearer the center than the end 191 can also be inclined similar to the guide holes 190a. Therefore, drying out of the areas near the ends 189, 191 of the collar member 124 can be more positively prevented.

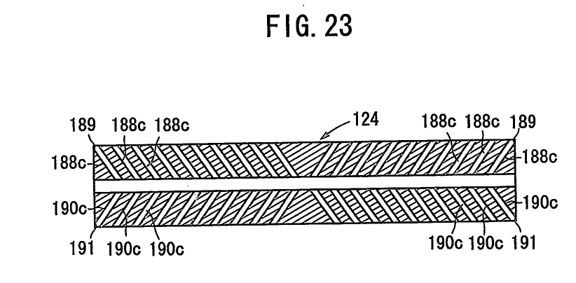

As can be seen in FIG. 23, all of the guide holes 188c, 190c can be symmetrically inclined with regards to the center region. In this manner, if all of guide holes 188c have the same shape, the process of cutting and forming the guide holes 188c will be easy.

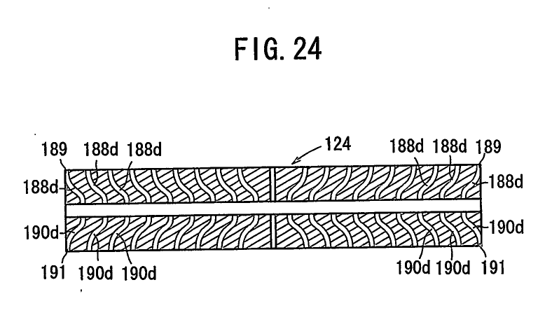

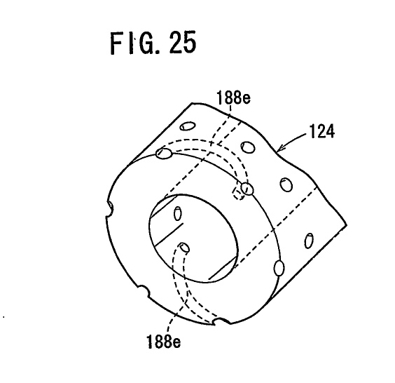

In addition, as shown in FIG. 24, guide holes 188d and 190d, may be formed from the inner surface to the outer surface in a curved manner in the axial direction towards end 189. As can be seen in FIG. 25, guide hole(s) 188e may have a spiral configuration, twisted in the axial direction.

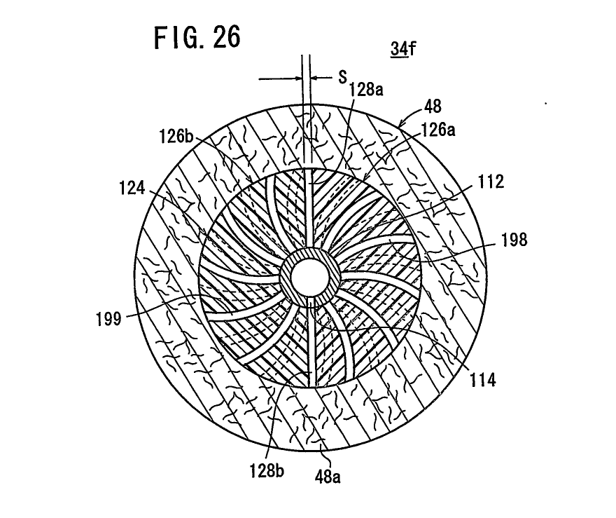

Next, a roller mechanism 34f according to the sixth alternate embodiment of the roller mechanism 34 will be described with reference to FIG. 26. The roller mechanism 34f has curved guide holes 198 and 199 in place of the guide holes 188, 190 in the roller mechanism 34e.

As is shown in FIG. 26, multiple curved guide holes (openings) 198, 199 which penetrate from the center of the collar member 124 in the radial direction, are provided in the sections 126a, 126b of the roller mechanism 34f. The curved guide holes 198, 199 are staggered in the outer region of sections 126a, 126b and uniformly dispersed in the axial direction.

With the roller mechanism 34f constructed in this manner, the multiple curved guide holes 198, 199 are provided in the sections 126a, 126b of the roller mechanism 34f. Therefore, the amount of the protective layer forming material applied can be changed, and a favorable coating operation can be executed for a specified application surface. Therefore, by selectively using the guide holes 188, 190 of the roller mechanism 34e and the curved guide holes 198, 199 of the roller mechanism 34f, the desired coating operation for the various types of application surfaces can effectively be performed. Note, it is not necessary to provide any grooves 128a, 128b for the roller mechanisms 34e, 34f.

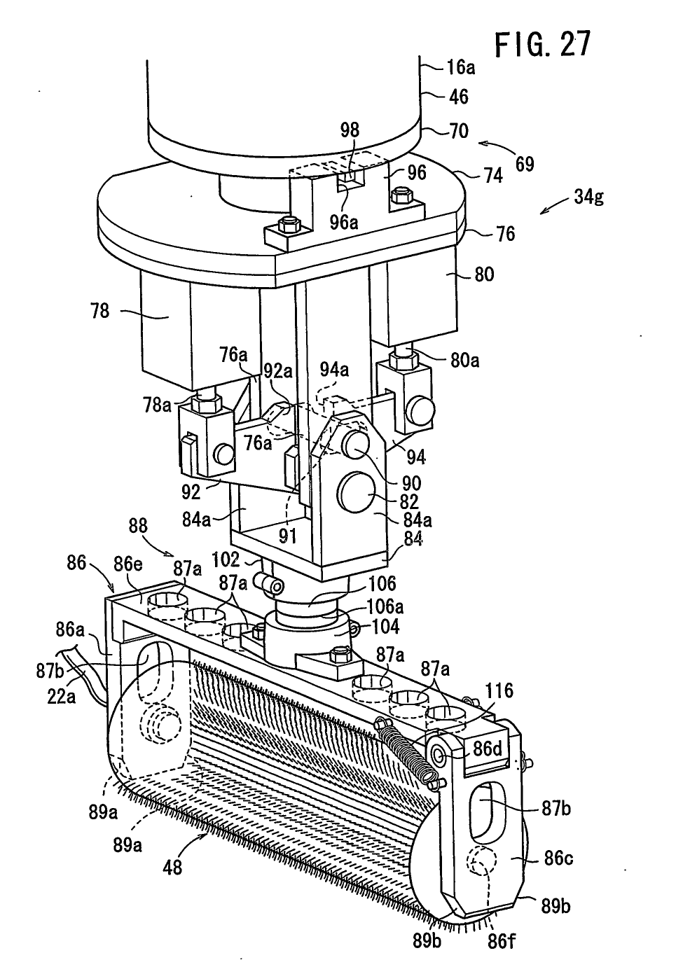

Next, a roller mechanism 34g according to the seventh alternate embodiment of the roller mechanism 34 will be described with reference to FIG. 27 through FIG. 30.

The holder main body 86e of the roller mechanism 34g has multiple a first penetrating holes 87a that penetrate from the clamp 104 side which is connected at the top, to the roller 48 side, and the first penetrating holes 87a are each formed with specific interval spacing. Note, the size and number of the first penetrating holes 87a may be set corresponding to the shape of the holder main body 86e.

On the other hand, a second penetrating holes 87b that are nearly rectangular are formed near the centers of the fixed holder 86a and the moveable holder 86c. The first and second holes 87a, 87b can, for example, be formed by a punch process.

Furthermore, the first penetrating hole 87a and the second penetrating hole 87b formed in the holder main body 86e, the fixed holder 86a and the moveable holder 86c are not limited to penetrating holes, and recessed regions with bottoms of suitable size and depth are also acceptable.

A pair of bevels (notches) 89a are formed at a fixed inclined angle on tip end side of the fixed holder 86a that supports the pipe 112, so that the width narrows toward the tip end (refer to FIG. 27).

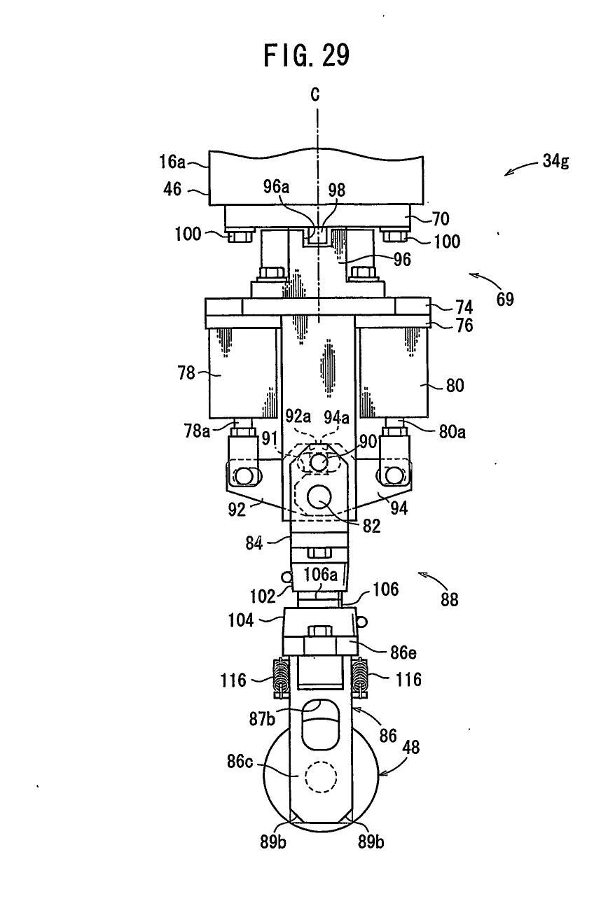

A pair of bevels (notches) 89b are formed at a fixed inclined angle on the tip end side of the moveable holder 86c that supports the pipe 112, so that the width narrows toward the tip end (refer to FIG. 29). The incline angle of the bevels 89a, 89b are cut at an angle so that the tip of the holder 86 will not contact the surface of the vehicle 14 when the roller 48 in the holder connector 88 comes into contact with the surface of the vehicle 14 in order to apply the protective layer forming material. Note, the bevel 89a on the fixed holder 86a and the bevel 89b on the moveable holder 86c are formed so that they are nearly the same angle. Note, the bevels 89a, 89b function as interference prevention in order to prevent interference with the vehicle 14.

In addition, in place of cutting the bevels 89a, 89b in a triangle on the fixed holder 86a and the moveable holder 86c, the tips of the fixed holder 86a and the moveable holder 86c may be formed in a cone. As a result, as in the case of the bevels 89a, 89b, the holder 86 can be prevented from touching the surface of the vehicle 14.

By forming the multiple first penetrating holes 87a or recessed regions with bottoms in the holder main body 86e of the holder 86 along with forming the second penetrating holes 87b or recessed region with bottom in both the fixed holder 86a and the moveable holder 86c, the weight of the holder 86 in the roller mechanism 34g can be reduced. Therefore, because the weight of the holder 86 is reduced, the moment of inertia, created by the pivoting movement of the holder connector 88 with the pivot shaft 82 as a fulcrum point, can be reduced. As a result, the holder connector 88 can pivot even more easily and smoothly, and the control of the pivot movement of the roller mechanism becomes easy.

Note, it is possible to just make the holder main body 86e, the fixed holder 86a, and the moveable holder 86c thinner in order to achieve a reduction in weight, however this greatly reduces the cross sectional second moment and strength becomes insufficient. On the other hand, by making the first penetrating holes 87a, the second penetrating holes 87b or recessed region with bottom, a reduction in the cross sectional second moment (moment of inertia) can be suppressed and strength maintained while reducing weight.

In addition, by cutting bevels 89a, 89b inclined at a fixed angle on the tips of the moveable holder 86c and the fixed holder 86a of the holder 86, when the holder connector 88 using the pivot shaft 82 as a fulcrum point pivots only through a designated angle, the holder 86 of the holder connector 88 can be prevented from touching the surface of the vehicle 14. In other words, along with achieving weight reduction of the holder 86 by the bevels 89a, 89b, the holder 86 can be prevented from touching the vehicle 14 when the roller 48 is used to apply the protective layer forming material.

Note, the use of combinations of portions of the functions from the roller mechanisms 34 through 34f is of course acceptable.

The peelable protection layer formed by the protective layer forming material can protect the painted regions after the vehicle 14 has been shipped, can protect the painted regions inside the plant as well, and also acts as a replacement for the scratch covers. Therefore, the many scratch covers with different shapes for each vehicle type can be omitted.

In addition, some bumpers of vehicles 14 are colored and do not require painting, but the protective layer forming material may also be applied to places that are not painted such as bumpers.

Although there have been described what are the present embodiments of the invention, it will be understood by persons skilled in the art that variations and modifications may be made thereto without departing from the spirit or essence of the invention. The scope of the invention is indicated by the appended claims.

1. A coating system for forming a protective layer, comprising:
a coating device which is movable according to information taught by an operator, and disposed near a transport line for an object to be coated;
a roller mechanism having a roller connected to said coating device;
a supply mechanism which supplies liquid material to said roller to form a peelable protective layer on said object after drying said liquid material;
a holder removably attached to said roller mechanism to support said roller; and
a pipe connected to said holder that delivers said liquid material to said roller and also supports said roller in a freely rotating manner.

2. A coating system according to claim 1, wherein said coating device is a robot and said object to be coated is a vehicle.

3. A coating system according to claim 1, wherein said holder comprises:
a holder main body that is parallel to said roller; and
a fixed holder and a moveable holder which both extend from ends of said holder main body in respective directions and that support ends of said pipe, wherein
said moveable holder is supported in a rotatable manner in said holder main body.

4. A coating system according to claim 3, wherein said moveable holder can be placed in either a support position where said roller is supported, or revolved with respect to said support position to an attach and remove position, using an elastic body.

5. A coating system according to claim 1, wherein said roller is equipped with:
a brush that contacts the outer surface of said object to be coated and applies said liquid material; and
end caps on the ends of said roller that are liquid tight and support said roller in a freely rotating manner by having said pipe pass therethrough.

6. A coating system according to claim 1, wherein
said pipe has a first end connected to a duct that supplies liquid material; and
an outer part of said pipe has multiple holes formed along the axial direction of said pipe, and holes near a second end of said pipe are formed with a larger diameter than holes near said first end.

7. A coating system according to claim 6, wherein intervals between holes near said second end of said pipe are smaller than intervals between holes near said first end of said pipe.

8. A coating system according to claim 1, wherein
said roller is equipped with a cylindrical brush base into which said liquid material is supplied, and a brush provided on the outer surface of said brush base; and
said brush base has multiple holes for transmitting supplied liquid material to said brush opened in the outer wall of brush base along an axial direction in a spiral or lattice manner.

9. A coating system according to claim 8, wherein said brush base is formed of paper impregnated with plastic.

10. A coating system according to claim 1, wherein
a cylindrical collar member is provided between said roller and said pipe; and
said collar member has openings which supply into said roller said liquid material as supplied to said collar member from holes defined in said pipe.

11. A coating system according to claim 10, wherein
said collar member is equipped with multiple sections divided in a radial direction; and
slit shaped grooves are formed as said openings extending in an axial direction of said roller on each said section.

12. A coating system according to claim 11, wherein
said collar member has multiple guide holes formed as said openings penetrating in the radial direction; and
said liquid material, supplied from said holes in said pipe to said guide holes, is discharged into said roller from outside of said collar member through said guide holes.

13. A coating system according to claim 12, wherein
said roller is equipped with a cylindrical brush at an outer portion thereof; and
at least one of said guide holes is formed in either an inclined or curved manner from an inner surface to an outer surface of said collar member in the axial direction towards an end of said collar member.

14. A coating system according to claim 12, wherein at least one of said guide holes penetrates an end of the outer circumference of said collar member.

15. A coating system according to claim 10, wherein said collar member comprises multiple sections divided in a radial direction.

16. A coating system according to claim 1, wherein said holder has either penetrating holes or a recessed region with a bottom.

17. A coating system according to claim 1, wherein said holder comprises:
a holder main body that is parallel to said roller; and
a fixed holder and a moveable holder that extend from both sides of said holder main body and support ends of said pipe,
wherein ends of said fixed holder and said moveable holder are cut to form cutaways at positions corresponding to a surface of the object to which said liquid material is applied, in order to prevent interference with said surface.

18. A coating system according to claim 1, wherein said liquid material is acrylic copolymer material.
